(19) United States
(12) Patent Application Publication
(10) Pub. No.: US 2007/0074775 A1
(43) Pub. Date: Apr. 5, 2007

(54) Apparatus for diverting flow of a liquid from an air conditioning condensate line drain

(76) Inventor: Ronald Logan, Jupiter, FL (US)

Correspondence Address: JAMES RAY & ASSOCIATES, 2640 Pitcaim Road, Monroeville, PA, 15146, US

(21) Appl. No.: 11/542,890

(22) Filed: Oct. 4, 2006

Related U.S. Application Data
(60) Provisional application No. 60/723,292, filed on Oct. 4, 2005.

(51) Int. Cl. F16L 3/00

(52) U.S. Cl. 138/106

(57) ABSTRACT

An apparatus for diverting flow of liquid from an air conditioning condensate line away from a foundation outside of a structure. The apparatus includes a tube member having an inlet end for receiving the liquid, a joint for changing direction of the flow of liquid through the tube member and an outlet end for releasing such liquid. A cup member is disposed on the inlet end for funneling the liquid from the condensate line into the inlet end. At least one positioning member is disposed under the tube member between the elbow joint and the outlet end for supporting and securing the tube member in place such that the cup member is positioned directly below the condensate line and a gradual slope is maintained between the inlet and outlet ends wherein predetermined height of the inlet end is greater than predetermined height of the outlet end.

### CROSS REFERENCE TO RELATED APPLICATION

This application is closely related to and claims benefit from U.S. Provisional Patent Application Ser. No. 60/723,292 filed on Oct. 4, 2005.

### FIELD OF THE INVENTION

The present invention relates, in general, to a condensate line that drains a liquid discharged from an air conditioning unit near the foundation outside of a structure and, more particularly, the invention relates to an apparatus designed to divert flow of the liquid from the air conditioning condensate line away from the foundation of the structure to a more advantageous location.

### BACKGROUND OF THE INVENTION

Prior to the conception and development of the present invention, as is generally well known in the prior art, air conditioning units have been installed with a condensate line that drains water discharged from the air conditioner directly outside near a foundation of the structure being cooled.

During times of the year an air conditioning unit can be running most of the day. In these conditions, there is a steady flow of water emitted from the air conditioning condensate line that can cause a puddle of water to accumulate around the outer foundations of homes and businesses.

This pervasive standing water is an attraction to mosquitoes, termites and other unwanted insects. In addition, the accumulated water can cause mold and potentially lead to problems with the foundation. There is a need to divert the water away from foundations to a more suitable location.

### SUMMARY OF THE INVENTION

The present invention provides an apparatus for diverting flow of a liquid from an air conditioning condensate line that drains near a foundation outside of a structure to a pre-selected location a predetermined distance from such foundation of such structure. The apparatus includes a tube like member having a predetermined length and a predetermined shape. The tube like member has an inlet end for receiving the liquid, a joint for changing direction of the flow of liquid through the tube like member from a generally vertical plane to a generally horizontal plane and an outlet end for releasing the liquid such predetermined distance away from the foundation of the structure. A cup like member, having a predetermined diameter and a predetermined depth, is disposed on the inlet end for funneling the liquid from the condensate line drain into the inlet end. A means is disposed under the tube like member between the joint and the outlet end for positioning and securing the tube like member in place such that the cup like member is positioned directly below such condensate line drain at a predetermined height above the ground to maintain a gradual slope between the inlet end and the outlet end of such tube like member wherein a predetermined height of the inlet end is greater than a predetermined height of the outlet end.

### OBJECTS OF THE INVENTION

It is, therefore, one of the primary objects of the present invention to provide an apparatus that can divert water that drains from an air conditioner condensate line around the outside foundations of homes and businesses.

Another object of the present invention is to provide an apparatus that will substantially eliminate water accumulating near the foundations of structures that can attract insects, cause mold and potentially damage the outside foundation of a structure.

Still another object of the present invention is to provide an apparatus to divert water draining from an air conditioner condensate line that is easy to manufacture.

Yet another object of the present invention is to provide an apparatus to divert water draining from an air conditioner condensate line that is easy to install.

In addition to the above described objects and advantages of the present invention, various additional objects and advantages of the apparatus used to divert water away from foundations according to the instant invention will become more readily apparent to those persons skilled in the relevant art from the following more detailed description, particularly, when such description is taken in conjunction with the attached drawing figures and with the appended claims.

### BRIEF DESCRIPTION OF THE DRAWINGS

FIG. 1 is a side elevation view of an apparatus according to one embodiment of the present invention;

FIG. 2 is a perspective side view of the apparatus according to another presently preferred embodiment of the invention; and

FIG. 3 is a perspective view of the apparatus of the present invention illustrated in FIG. 2 installed to divert water from the air conditioning condensate line away from the foundation of the structure.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity in understanding the invention, identical components having identical functions have been identified with identical reference numerals throughout the several views illustrated in the drawings.

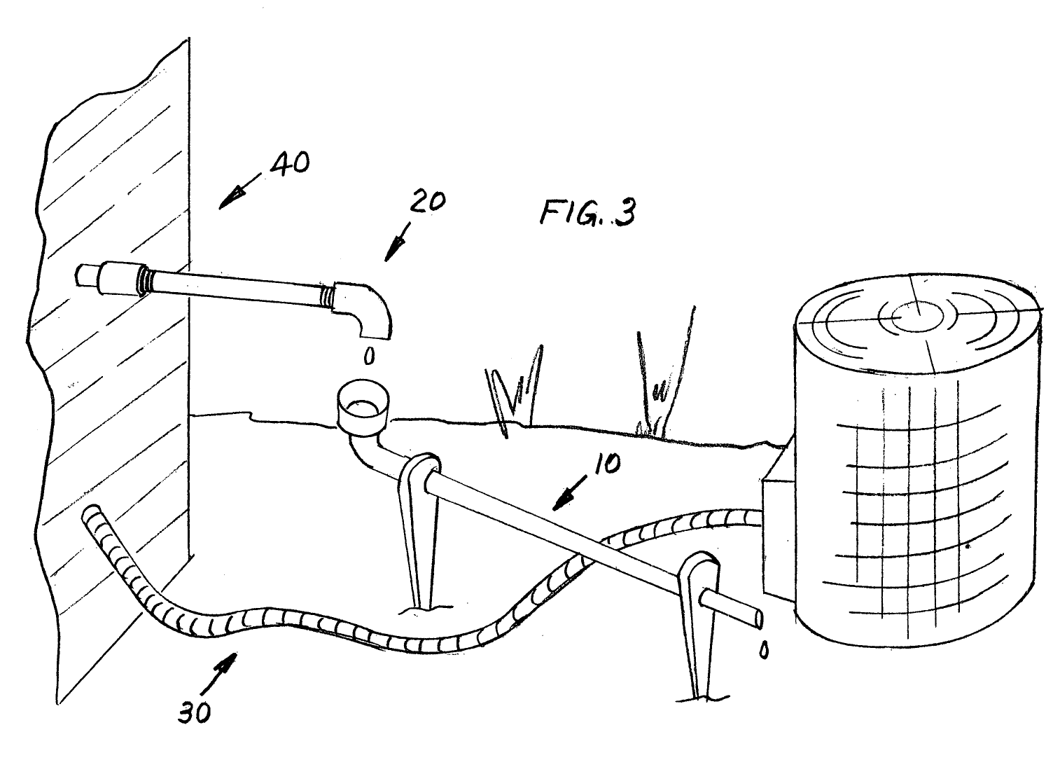

Now reference is made, more particularly, to the drawing FIGS. 1-3. Illustrated therein is an apparatus, generally designated 10, for diverting flow of a liquid from an air conditioning condensate line, generally designated 20, that drains near a foundation, generally designated 30, outside of a structure, generally designated 40, to a pre-selected location a predetermined distance from the foundation 30 of structure 40.

The apparatus 10 includes a tube like member 12 having a predetermined length and a predetermined shape. The tube like member 12 includes an inlet end 14 for receiving such liquid, a pre-selected joint 16, preferably an elbow, for changing the direction of the flow of liquid through the tube like member 12 from a generally vertical plane to a generally horizontal plane and an outlet end 18 for releasing the liquid such predetermined distance away from the foundation 30 of structure 40.

The predetermined length of the tube like member 12 is, preferably, between about four feet and about seven feet. Also, the tube like member 12 is, preferably, made from a 3/4 inch tubing.

The apparatus 10 includes a cup like member 22 having a predetermined diameter and a predetermined depth. The cup like member 22 is disposed on the inlet end 14 for funneling the liquid from the air conditioning condensate line 20 into the inlet end 14. The predetermined diameter of an opening of the cup like member 22 is, preferably, about five inches.

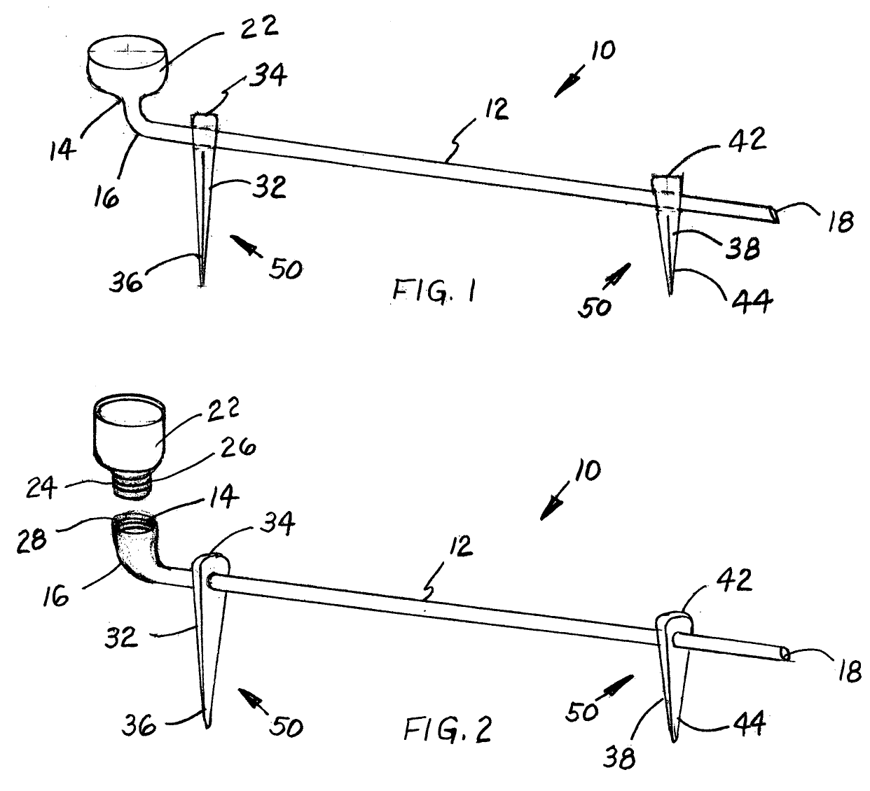

In one embodiment of the present invention, illustrated in FIG. 1, the cup like member 22 is integrally formed with the inlet end 14 of the tube like member 12. However, illustrated in FIG. 2, the cup like member 22 may include a bottom cylinder 24 having an outer threaded portion 26 for threading into the inlet end 14 which has an inner threaded portion 28.

The apparatus 10 further includes a means, generally designated 50, disposed under the tube like member 12 between the elbow joint 16 and the outlet end 18 for positioning and securing the tube like member 12 in place such that the cup like member 22 is positioned directly below the air conditioning condensate line 20 at a predetermined height above ground to maintain a gradual slope between the inlet end 14 and the outlet end 18 of the tube like member 12 wherein a predetermined height of the inlet end 14 is greater than a predetermined height of the outlet end 18.

In a presently preferred embodiment of the present invention, the means 50 will include at least one stake like member 32 having a first end 34 attached to tube like member 12 adjacent the elbow joint 16 and a second end 36 for driving into the ground a predetermined depth sufficient to position and secure the tube like member 12 in place.

In one embodiment of the present invention, the at least one stake like member 32 will be integrally formed with the tube like member 12. Alternatively, the at least one stake like member 32 could be adhesively bonded to the tube like member 12.

In another presently preferred embodiment of the present invention, the at least one stake like member 32 can be adjusted to allow for varying heights of the air conditioning condensate line 20 above the ground.

In another embodiment, The means 50 may include two stake like members. A second stake like member 38 will have a first end 42 attached to the tube like member 12 between the first stake like member 32 and the outlet end 18 and a second end 44 for driving into the ground a predetermined depth sufficient to position and secure the tube like member 12 in place.

In this embodiment, the first 32 and the second 38 stake like members will, preferably, be integrally formed with the tube like member 12. However, the first 32 and the second 38 stake like members could be adhesively bonded to the tube like member 12. Preferably, in this embodiment, the first 32 and second 38 stake like members are capable of being adjusted to allow for varying heights of the air conditioning condensate line 20 above ground.

In a most presently preferred embodiment of the present invention, the apparatus 10 will be manufactured from a durable, water resistant material. Also, the apparatus 10 can preferably be manufactured in various colors.

While a presently preferred and various alternative embodiments of the present invention have been described in detail above it should be understood that various other embodiments of the invention can be envisioned by those persons skilled in the relevant art without departing from the spirit of the invention or the scope of the appended claims.

I claim:

1. An apparatus for diverting flow of a liquid from an air conditioning condensate line that drains near a foundation outside of a structure to a pre-selected location a predetermined distance from such foundation of such structure, said apparatus comprising:
(a) a tube like member having a predetermined length and a predetermined shape, said tube like member including an inlet end for receiving such liquid, a joint for changing a direction of such flow of such liquid through said tube like member from a generally vertical plane to a generally horizontal plane and an outlet end for releasing such liquid such predetermined distance away from such foundation of such structure;
(b) a cup like member having a predetermined diameter and a predetermined depth disposed on said inlet end for funneling such liquid from such condensate line drain into said inlet end; and
(c) a means disposed under said tube like member between said joint and said outlet end for positioning and securing said tube like member in place such that said cup like member is positioned directly below such condensate line drain at a predetermined height above ground to maintain a gradual slope between said inlet end and said outlet end of said tube like member wherein a predetermined height of said inlet end is greater than a predetermined height of said outlet end.

2. An apparatus, according to claim 1, wherein said predetermined length of said tube like member is between about four feet and about seven feet.

3. An apparatus, according to claim 1, wherein said tube like member is about a 3/4 inch tube.

4. An apparatus, according to claim 1, wherein said predetermined diameter of an opening of said cup like member is about five inches.

5. An apparatus, according to claim 1, wherein said cup like member is formed integrally with said inlet end of said tube like member.

6. An apparatus, according to claim 1, wherein said cup like member includes a bottom cylinder having an outer threaded portion for threading into said inlet end having an inner threaded portion.

7. An apparatus, according to claim 1, wherein said means includes at least one stake like member having a first end attached to said tube like member adjacent said joint and a second end for driving into ground a predetermined depth sufficient to position and secure said tube like member in place.

8. An apparatus, according to claim 7, wherein said at least one stake like member is integrally formed with said tube like member.

9. An apparatus, according to claim 7, wherein said at least one stake like member is adhesively bonded to said tube like member.

10. An apparatus, according to claim 7, wherein said at least one stake like member is capable of being adjusted to allow for varying heights of such condensate line drain above ground.

11. An apparatus, according to claim 1, wherein said means includes two stake like members, a first stake like member having a first end attached to said tube like member adjacent said joint and a second end for driving into ground a predetermined depth sufficient to position and secure said tube like member in place and a second stake like member having a first end attached to said tube like member between said first stake like member and said outlet end and a second end for driving into ground a predetermined depth sufficient to position and secure said tube like member in place.

12. An apparatus, according to claim 11, wherein said first and said second stake like members are integrally formed with said tube like member.

13. An apparatus, according to claim 11, wherein said first and said second stake like members are adhesively bonded to said tube like member.

14. An apparatus, according to claim 11, wherein said first and said second stake like members are capable of being adjusted to allow for varying heights of such condensate line drain above ground.

15. An apparatus, according to claim 1, wherein said apparatus is manufactured from a durable, water resistant material.

16. An apparatus, according to claim 1, wherein said apparatus is manufactured in various colors.
